(19) United States
(12) Patent Application Publication
(10) Pub. No.: US 2012/0077147 A1
(43) Pub. Date: Mar. 29, 2012

(54) Swivel Head Microimplant Wrench

(76) Inventor: John T. Kalange, Boise, ID (US)

(21) Appl. No.: 13/249,234

(22) Filed: Sep. 29, 2011

Related U.S. Application Data
(60) Provisional application No. 61/387,913, filed on Sep. 29, 2010.

(51) Int. Cl. A61C 13/12; A61C 1/10

(52) U.S. Cl. 433/114; 433/172

(57) ABSTRACT

The present invention relates to an instrument used to insert microimplants and more particularly, to a microimplant insertion wrench that has a head on the instrument that allows the head to swivel and rotate upon the handle. The end of the head of the instrument comprises a receptacle that receives and retains a microimplant. The head of the implant wrench can be fixed into a predetermined angulation with the aid of a set screw. Microimplants can be inserted by a counter clockwise rotation of the knurled knob on the head of the instrument, and implants can be removed by clockwise rotation of the knurled knob on the head of the implant wrench.

### RELATED APPLICATIONS

The present application is a continuation-in-part application of U.S. provisional patent application Ser. No. 61/387,913, filed Sep. 28, 2011, for SWIVEL HEAD MICROIMPLANT WRENCH, by John T. Kalange, included by reference herein and for which benefit of the priority date is hereby claimed.

### FIELD OF THE INVENTION

The present invention relates to an instrument used to insert microimplants and more particularly, to a microimplant insertion wrench that has a head on the instrument that allows the head to swivel and rotate upon the handle.

### BACKGROUND OF THE INVENTION

The following text should not be construed as an admission of knowledge in the prior art. Furthermore, citation of identification of any document in this application is not an admission that such document is available as prior art to the present invention, or that any reference forms a part of the common general knowledge in the art.

In the treatment of orthodontic patients, it is frequently quite necessary to place attachments on several of the teeth. These attachments allow for the placement of forces to the jaws for orthopedic correction, and to the teeth which allow for orthodontic tooth movement. One of these attachments is an item which in conventionally called an orthodontic bracket which is attached to the buccal or cheek-side part of the tooth, and which is a cast metal or milled bracket. This bracket is adhered to any of the teeth. In particular, the proposed item would be attached to any of the upper or lower molar teeth and would be directly bonded to the teeth with an acrylic resin. The bracket is typically used for receiving another orthodontic device such as a headgear facebow, lip bumper, class II corrector (overbite corrector), archwire, or other device.

In conventional orthodontic treatment, the application of forces to an orthodontic bracket allows for tooth movement. When forces are placed between two or more teeth, Newton's third law comes into affect and there is an equal and opposite reaction between the units in which the forces are placed. Quite often this reaction is undesirable, and certain teeth will move when the objective is to have them remain stationary. By placing a microimplant (which is a non-biological unit) into the bone adjacent to teeth, forces between a tooth or teeth and the microimplant allow for the teeth to be moved but not the microimplant. This concept is referred to as, “anchorage.” Microimplants are placed to create anchorage units.

The installation of these microimplants utilizes various instruments for their placement. Specifically, one of the instruments is a wrench. The microimplant is inserted into the head of the wrench. The wrench is then inserted into the mouth, and the tip of the implant placed in the area where it is intended to be placed. The wrench is then twisted or rotated in a conventional manner and the microimplant is screwed into place.

The currently proposed patent application, includes a wrench in which the head swivels or rotates upon the handle. This rotation and swiveling allows for enhanced access to areas that are traditionally very difficult to access.

Previous inventions have discussed implant wrenches in various forms. Specifically, U.S. Pat. No. 5,368,480 by Balfour describes an implant wrench that has an insert that shears at a predetermined level of torque. However, this design is specifically for larger diameter implants unrelated to the concept of anchorage. U.S. Pat. No. 6,109,150 by Saccomanno, and U.S. Pat. No. 7,100,476 by Feit describes implant wrenches that have an adjustable mechanism that allow for selection of specific torque values that are placed on the implant during placement. As with the previously discussed invention, these invention are for use on conventional implants of a larger diameter in which the torque values during placement are of value. The placement of microimplants are such that the torque values during placement are so small as to be insignificant, and therefore implant wrenches with adjustable torque values are useless. A related invention by Meulink, U.S. Pat. No. 6,330,845 describes an implant wrench that has a design in which the implant head is restrained during placement, however, this implant wrench has no adjustability for angulations as the one described in this invention. U.S. Pat. No. 5,904,689 by Jonjic describes a surgical screwdriver in which the head of the screwdriver has variable angulations. However, this invention is related to a screwdriver which is an instrument unrelated to the invention described which is a wrench.

Existing inventions are specifically designed for dental or medical implants and are utilized on implants of large diameters. The instrument described is specifically for implants which have diameters in the area of 2.0 mm and are considered microimplants. With all microimplant instruments including a microimplant wrench, the placement of the microimplant occurs in very discrete but localized areas of the mouth. Access to these areas is critical for proper placement. Conventional implant wrench as well as those that have been used for microimplants traditionally have the implant exiting 90 degrees from the handle. This presents a problem in areas of the mouth that have limited access. An implant wrench with a head that rotates or swivels upon the handle allows for the operator to vary the angulations at which the implant exits the instrument, and enhances and improves it's usefulness. would be advantageous to provide a microimplant wrench that allows insertion of a microimplant into a receptacle on the head of the implant

It would also be advantageous to provide a microimplant wrench in which the head of the microimplant wrench allows for a swiveling or rotational movement of the head which in turn allows for varying the angulations of the implant in relationship to the handle.

It would further be advantageous to provide a microimplant wrench in which the direction of the microimplant relative to the handle could be varied to an established predetermined angulations and set at that angulations by locking the microimplant wrench head into position with a set screw.

It would further be advantageous to provide a microimplant wrench that provides a mechanism in which an implant that is inserted into a receptacle in the head is inserted by rotation of the handle.

### SUMMARY OF THE INVENTION

The shortcomings of the prior art discussed above are addressed by the various embodiments of the present invention. It is to be understood that the present invention includes a variety of different versions or embodiments, and this Summary is not meant to be limiting or all-inclusive. This Summary provides some general descriptions of some of the embodiments, but may also include some more specific descriptions of certain embodiments.

In accordance with the embodiments of the present invention, an instrument comprises a wrench designed for the insertion of microimplants used for orthodontic anchorage. The wrench having a receptacle into which the microimplant is received. This receptacle would be made available for a variety of different implant sizes and lengths and of various head configurations.

In accordance with the embodiments of the present invention, an implant wrench with a head that rotates and swivels allows for the direction of implant placement to be varied. The variation of the direction of the implant allows for better access to certain areas of the mouth.

Thus, in accordance with embodiments of the present invention, a microimplant wrench allows for the insertion of a microimplant by insertion of the microimplant into the head of the microimplant wrench, the head of which allows for a rotation or swiveling movement.

In another embodiment of the invention, a microimplant wrench allows for the insertion of a microimplant by insertion of the microimplant into the head of the microimplant wrench, the head of which allows for a rotation or swiveling movement. The angulations of which could be determined, and then a set screw could be used to prevent further swiveling or rotation of this head. Therefore, the implant to implant wrench head angulations could be established at a predetermined angulations of say 55 degrees or a similar angulations.

In yet another embodiment of the invention, a implant wrench with a rotating or swiveling head is provided, the implant wrench comprising a head and a handle, the head of which could be varied for the acceptance of a plurality of implant sized and configurations.

In accordance with the embodiments of the present invention, a implant wrench is provided, the handle of which engages gears within the head of the implant wrench. When the handle is rotated, gears within the head are set in motion. This motion of the gears turns a spindle which is part of the head of the wrench. When an microimplant is placed within the receptacle located on the spindle, the action of rotation of the handle serves to rotate the microimplant and affects insertion of the microimplant.

Other aspects of various embodiments not summarized here are also considered to form a part of the present invention, either alone or in combination with other aspects.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an entity refers to one or more of that entity. As such, the terms “a” (or “an”), “one or more” and “at least one” can be used interchangeably herein. It is also to be noted that the terms “comprising”, “including”, and “having” can be used interchangeably.

Various embodiments of the present invention are set forth in the attached figures and in the detailed description of the invention as provided herein and as embodied by the claims. It should be understood, however, that this Summary does not contain all of the aspects and embodiments of the present invention, is not meant of be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a front view of the embodiments of the present invention;

FIG. 2 is a front view of a front view of the implant wrench handle;

FIG. 3 is an exploded view of an exploded view of the microimplant swivel head implant wrench;

FIG. 4 is a rear detail view of the implant wrench head view of a rear detail view of the implant wrench head; and

FIG. 5 is a lateral view of a microimplant in orientation to the receiving end of the microimplant wrench.

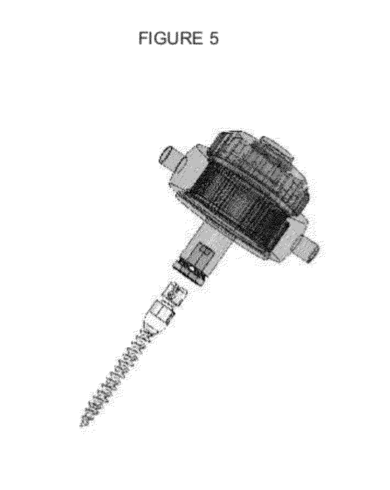

For purposes of clarity and brevity, like elements and components will bear the same designations and numbering throughout the Figures.

### DESCRIPTION OF THE PREFERRED EMBODIMENT

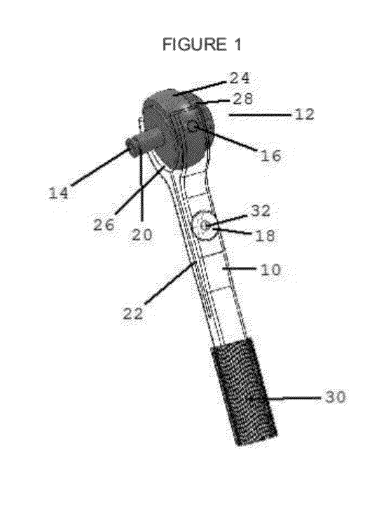

FIG. 1 is a front view of a front view of the embodiments of the present invention.

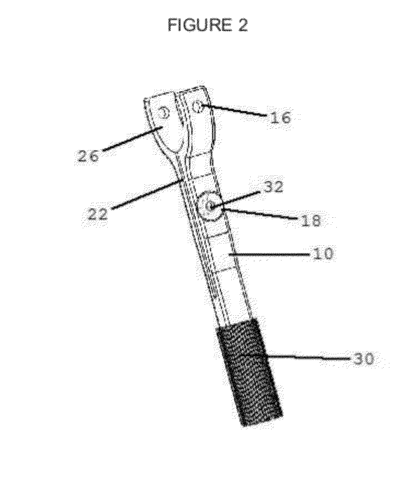

FIG. 2 is a front view of the implant wrench handle.

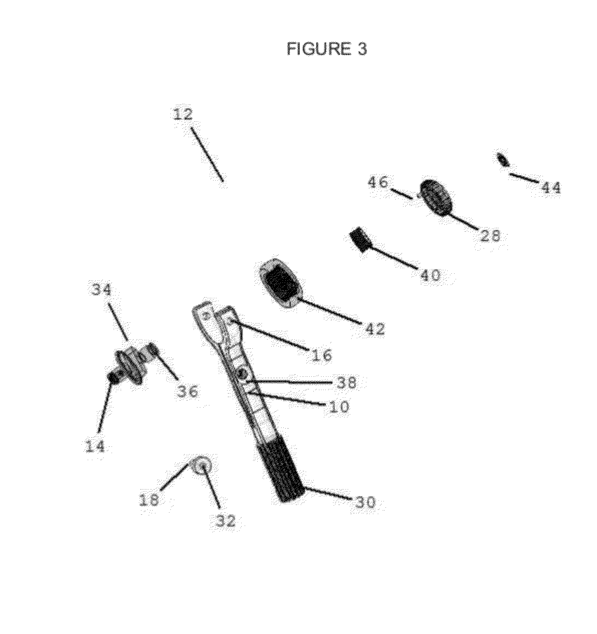

FIG. 3 is an exploded view of the microimplant 48 swivel head implant wrench.

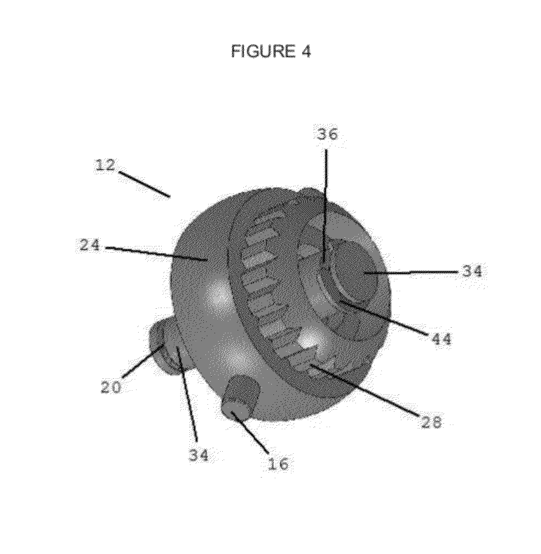

FIG. 4 is a rear detail view of the implant wrench head 12.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A swivel head microimplant wrench for the insertion of various microimplants that facilitates the application of forces to be placed on the teeth and jaws, comprising:
means for acceptance of head of the implant wrench and to act as a lever arm in the placement of the implant;
means for acceptance of the microimplant into the recepticle on the end, rotatably coupled to said means for acceptance of head of the implant wrench and to act as a lever arm in the placement of the implant;
means for acceptance of the microimplant;
means for allowing rotation and swiveling of the head of the wrench;
means for setting the head of the microimplant wrench in a desired position and prevent further rotation, adjustably screwed to said means for acceptance of head of the implant wrench and to act as a lever arm in the placement of the implant;
means for acceptance of a clip to aid in the retention of the microimplant into the head of the implant wrench during insertion of the microimplant, circularly constructed on to said means for acceptance of the microimplant;
means for allowing flexibility in the handle of the instrument. when the set screw is tightened, this area flexes and allows for compression of the ends of the handle against the rotating portion of the head, and prevents further rotation, centrally cut out of to said means for acceptance of head of the implant wrench and to act as a lever arm in the placement of the implant;
means for providing a convex surface that meets the concave portion of the end of the handle, and provides a rotation point, concentrically located within to said means for acceptance of the microimplant into the recepticle on the end;
means for providing a concave surface that meets the concex portion of the head of the implant wrench, and provides a rotation point, angularly cut out of to said means for acceptance of head of the implant wrench and to act as a lever arm in the placement of the implant;
means for adjustment of the direction of rotation of the head of the implant wrench. when the knurled knob is rotated clockwise, the wrench serves to rotate the implant in a counter clockwise direction (removal). when the knurled knob is rotated counterclockwise, the wrench serves to rotate the implant in a clockwise direction (insertion);
means for creation of a non-slip friction area on the handle of the implant wrench, axially constructed on to said means for acceptance of head of the implant wrench and to act as a lever arm in the placement of the implant;
means for acceptance of a hex head wrench as a means of tightening or loosening the set screw;
means for acceptance of the microimplant, and for engagement of the gears within the head of the implant to create rotation of the spindle, structurally a part of to said means for acceptance of the microimplant, and rigidly inserted to said means for acceptance of the microimplant into the recepticle on the end;
means for reception of the retention clip, rotationally constructed on to said means for acceptance of the microimplant, and for engagement of the gears within the head of the implant to create rotation of the spindle;
means for reception of the set screw;
means for assisting in the creation of a ratchet action during insertion of the microimplant;
means for assisting in the creation of a ratchet action during insertion of the microimplant;
means for retaining the elements of the implant wrench head into the implant wrench head, replaceably connected to said means for reception of the retention clip; and
means for engaging the gear in the head of the microimplant wrench. engagement in one direction results in clockwise rotation of the microimplant. engagement of the gear in the other direction results in counterclockwise rotation of the microimplant.

2. The swivel head microimplant wrench in accordance with claim 1, wherein said means for acceptance of head of the implant wrench and to act as a lever arm in the placement of the implant comprises a microimplant wrench handle.

3. The swivel head microimplant wrench in accordance with claim 1, wherein said means for acceptance of the microimplant into the recepticle on the end comprises an implant wrench head.

4. The swivel head microimplant wrench in accordance with claim 1, wherein said means for acceptance of the microimplant comprises a microimplant recepticle.

5. The swivel head microimplant wrench in accordance with claim 1, wherein said means for allowing rotation and swiveling of the head of the wrench comprises a pivot point.

6. The swivel head microimplant wrench in accordance with claim 1, wherein said means for setting the head of the microimplant wrench in a desired position and prevent further rotation comprises a set screw.

7. The swivel head microimplant wrench in accordance with claim 1, wherein said means for acceptance of a clip to aid in the retention of the microimplant into the head of the implant wrench during insertion of the microimplant comprises a recess for implant retention clip.

8. The swivel head microimplant wrench in accordance with claim 1, wherein said means for allowing flexibility in the handle of the instrument. when the set screw is tightened, this area flexes and allows for compression of the ends of the handle against the rotating portion of the head, and prevents further rotation comprises a provides flexibility of the handle as it attaches to the head cutout grove.

9. The swivel head microimplant wrench in accordance with claim 1, wherein said means for providing a convex surface that meets the concave portion of the end of the handle, and provides a rotation point comprises an allows for rotation of the head around an axis rounded portion of the head of the implant wrench.

10. The swivel head microimplant wrench in accordance with claim 1, wherein said means for providing a concave surface that meets the concex portion of the head of the implant wrench, and provides a rotation point comprises an allows for rotation of the implant head rounded portion of the handle.

11. The swivel head microimplant wrench in accordance with claim 1, wherein said means for adjustment of the direction of rotation of the head of the implant wrench. when the knurled knob is rotated clockwise, the wrench serves to rotate the implant in a counter clockwise direction (removal). when the knurled knob is rotated counterclockwise, the wrench serves to rotate the implant in a clockwise direction (insertion) comprises a creates a point where fingers can be used to rotate the adjusting portion of the head of the implant wrench knurled knob of implant wrench head.

12. The swivel head microimplant wrench in accordance with claim 1, wherein said means for creation of a non-slip friction area on the handle of the implant wrench comprises an area of frictional resistance knurled knob of implant wrench handle.

13. The swivel head microimplant wrench in accordance with claim 1, wherein said means for acceptance of a hex head wrench as a means of tightening or loosening the set screw comprises a hexagonal cutout.

14. The swivel head microimplant wrench in accordance with claim 1, wherein said means for acceptance of the microimplant, and for engagement of the gears within the head of the implant to create rotation of the spindle comprises a microimplant wrench spindle.

15. The swivel head microimplant wrench in accordance with claim 1, wherein said means for reception of the retention clip comprises a spindle cutout.

16. The swivel head microimplant wrench in accordance with claim 1, wherein said means for reception of the set screw comprises a countersunk and threaded for reception of the set screw counter sunk hole in handle.

17. The swivel head microimplant wrench in accordance with claim 1, wherein said means for assisting in the creation of a ratchet action during insertion of the microimplant comprises a has teeth to engage the inside of the rotating portion of the head gear.

18. The swivel head microimplant wrench in accordance with claim 1, wherein said means for assisting in the creation of a ratchet action during insertion of the microimplant comprises a has teeth on the inside that engage the gear rotating portion of the head of the implant wrench.

19. The swivel head microimplant wrench in accordance with claim 1, wherein said means for retaining the elements of the implant wrench head into the implant wrench head comprises a retention clip.

20. The swivel head microimplant wrench in accordance with claim 1, wherein said means for engaging the gear in the head of the microimplant wrench. engagement in one direction results in clockwise rotation of the microimplant. engagement of the gear in the other direction results in counterclockwise rotation of the microimplant comprises a set pin.

21. A swivel head microimplant wrench for the insertion of various microimplants that facilitates the application of forces to be placed on the teeth and jaws, comprising:
a microimplant wrench handle, for acceptance of head of the implant wrench and to act as a lever arm in the placement of the implant;
an implant wrench head, for acceptance of the microimplant into the recepticle on the end, rotatably coupled to said microimplant wrench handle;
a microimplant recepticle, for acceptance of the microimplant;
a pivot point, for allowing rotation and swiveling of the head of the wrench;
a set screw, for setting the head of the microimplant wrench in a desired position and prevent further rotation, adjustably screwed to said microimplant wrench handle;
a recess for implant retention clip, for acceptance of a clip to aid in the retention of the microimplant into the head of the implant wrench during insertion of the microimplant, circularly constructed on to said microimplant recepticle;
a provides flexibility of the handle as it attaches to the head cutout grove, for allowing flexibility in the handle of the instrument. when the set screw is tightened, this area flexes and allows for compression of the ends of the handle against the rotating portion of the head, and prevents further rotation, centrally cut out of to said microimplant wrench handle;
an allows for rotation of the head around an axis rounded portion of the head of the implant wrench, for providing a convex surface that meets the concave portion of the end of the handle, and provides a rotation point, concentrically located within to said implant wrench head;
an allows for rotation of the implant head rounded portion of the handle, for providing a concave surface that meets the concex portion of the head of the implant wrench, and provides a rotation point, angularly cut out of to said microimplant wrench handle;
a creates a point where fingers can be used to rotate the adjusting portion of the head of the implant wrench knurled knob of implant wrench head, for adjustment of the direction of rotation of the head of the implant wrench. when the knurled knob is rotated clockwise, the wrench serves to rotate the implant in a counter clockwise direction (removal). when the knurled knob is rotated counterclockwise, the wrench serves to rotate the implant in a clockwise direction (insertion);
an area of frictional resistance knurled knob of implant wrench handle, for creation of a non-slip friction area on the handle of the implant wrench, axially constructed on to said microimplant wrench handle;
a hexagonal cutout, for acceptance of a hex head wrench as a means of tightening or loosening the set screw;
a microimplant wrench spindle, for acceptance of the microimplant, and for engagement of the gears within the head of the implant to create rotation of the spindle, structurally a part of to said microimplant recepticle, and rigidly inserted to said implant wrench head;
a spindle cutout, for reception of the retention clip, rotationally constructed on to said microimplant wrench spindle;
a countersunk and threaded for reception of the set screw counter sunk hole in handle, for reception of the set screw;
a has teeth to engage the inside of the rotating portion of the head gear, for assisting in the creation of a ratchet action during insertion of the microimplant;
a has teeth on the inside that engage the gear rotating portion of the head of the implant wrench, for assisting in the creation of a ratchet action during insertion of the microimplant;
a retention clip, for retaining the elements of the implant wrench head into the implant wrench head, replaceably connected to said spindle cutout; and
a set pin, for engaging the gear in the head of the microimplant wrench. engagement in one direction results in clockwise rotation of the microimplant. engagement of the gear in the other direction results in counterclockwise rotation of the microimplant.

22. A swivel head microimplant wrench for the insertion of various microimplants that facilitates the application of forces to be placed on the teeth and jaws, comprising:
a microimplant wrench handle, for acceptance of head of the implant wrench and to act as a lever arm in the placement of the implant;
an implant wrench head, for acceptance of the microimplant into the recepticle on the end, rotatably coupled to said microimplant wrench handle;
a microimplant recepticle, for acceptance of the microimplant;
a pivot point, for allowing rotation and swiveling of the head of the wrench;
a set screw, for setting the head of the microimplant wrench in a desired position and prevent further rotation, adjustably screwed to said microimplant wrench handle;
a recess for implant retention clip, for acceptance of a clip to aid in the retention of the microimplant into the head of the implant wrench during insertion of the microimplant, circularly constructed on to said microimplant recepticle;
a provides flexibility of the handle as it attaches to the head cutout grove, for allowing flexibility in the handle of the instrument. when the set screw is tightened, this area flexes and allows for compression of the ends of the handle against the rotating portion of the head, and prevents further rotation, centrally cut out of to said microimplant wrench handle;
an allows for rotation of the head around an axis rounded portion of the head of the implant wrench, for providing a convex surface that meets the concave portion of the end of the handle, and provides a rotation point, concentrically located within to said implant wrench head;
an allows for rotation of the implant head rounded portion of the handle, for providing a concave surface that meets the concex portion of the head of the implant wrench, and provides a rotation point, angularly cut out of to said microimplant wrench handle;
a creates a point where fingers can be used to rotate the adjusting portion of the head of the implant wrench knurled knob of implant wrench head, for adjustment of the direction of rotation of the head of the implant wrench. when the knurled knob is rotated clockwise, the wrench serves to rotate the implant in a counter clockwise direction (removal). when the knurled knob is rotated counterclockwise, the wrench serves to rotate the implant in a clockwise direction (insertion);
an area of frictional resistance knurled knob of implant wrench handle, for creation of a non-slip friction area on the handle of the implant wrench, axially constructed on to said microimplant wrench handle;
a hexagonal cutout, for acceptance of a hex head wrench as a means of tightening or loosening the set screw;
a microimplant wrench spindle, for acceptance of the microimplant, and for engagement of the gears within the head of the implant to create rotation of the spindle, structurally a part of to said microimplant recepticle, and rigidly inserted to said implant wrench head;
a spindle cutout, for reception of the retention clip, rotationally constructed on to said microimplant wrench spindle;
a countersunk and threaded for reception of the set screw counter sunk hole in handle, for reception of the set screw;
a has teeth to engage the inside of the rotating portion of the head gear, for assisting in the creation of a ratchet action during insertion of the microimplant;
a has teeth on the inside that engage the gear rotating portion of the head of the implant wrench, for assisting in the creation of a ratchet action during insertion of the microimplant;
a retention clip, for retaining the elements of the implant wrench head into the implant wrench head, replaceably connected to said spindle cutout; and
a set pin, for engaging the gear in the head of the microimplant wrench. engagement in one direction results in clockwise rotation of the microimplant. engagement of the gear in the other direction results in counterclockwise rotation of the microimplant.
